(19) United States
(12) Patent Application Publication
(10) Pub. No.: US 2003/0134258 A1
(43) Pub. Date: Jul. 17, 2003

(54) Speech coordinator

(76) Inventor: Emery C. Teichelman, Taylor, TX (US)

Correspondence Address: Emery C. Teichelman, 1800 Granger Road, Taylor, TX, 76574, US

(21) Appl. No.: 10/043,063

(22) Filed: Jan. 11, 2002

(51) Int. Cl. G09B 19/04

(52) U.S. Cl. 434/185

(57) ABSTRACT

An elongated tool (10) said tool-having opening at each end (14,42). Said first opening can be adjustable for colored dots or symbols. Said adjustments by any material can be held in place by glue or tape (14). Colored dots or symbols are used with shaded or colored card chart. (22), having approximately ½ inch shaded or bright colors or symbols. Said colored dots or symbols (30) are staggered throughout the card chart (22), said tool (10) is used to scan squares through opening (14) Said patient will speak where location dots or symbols (30) opening (14) tool (10). This timing coordinates the articulatory systems thus improving enumerciation of words. Said second opening (42) located opposite end has lengths and height larger enough to read only one word, this will regulate rate of speed enabling patient to pronounce words more clearly.

### BACKGROUND OF THE INVENTION

Parkinson's Disease has been around many years. Most mysterious is the cause, which is unknown. Once a person gets Parkinson's disease, there is no cure; you must learn to live with it.

Parkinson's Disease has been referred to as an ailment of old age. But recent studies indicate that the incidence of new cases reaches a peak at about age 55. About half the victims are affected during this time frame, and about ten percent of cases appear before age 40. It strikes both men and women with a slightly higher percentage of men than women.

Symptoms include tremors, rigidity, and slowness of movement. Other major symptoms that develop over a period of time include stooped posture, a soft and indistinct voice, a slurred and mumbled speech, and balance problems, known as postural instability. Parkinson's Disease is a slowly progressive neurological condition that affects the coordination of muscles used for speech and voice. It is estimated that 75% of individuals with Parkinson's disease experience changes in voice and speech production at some point through the course of the disease. It is reported that 4% of individuals report changes in speech and voice as the first Parkinson's disease symptoms noticed.

With the recent advances in anti-Parkinson medication, many individuals are moving and functioning better that ever before. While medications are the primary tool for management of Parkinson's disease, the effect of those agents on speech and voice deficits are harder to measure. Even anecdotal accounts from persons with Parkinson's disease are inconsistent. A majority of individuals with Parkinson's disease states that they notice little change, either positive or negative, in speech and voice ability related to changes in medication regime.

A relatively new augmentative communication system, that amplifies the voice and improves speech clarity through a filtering system, can be beneficial for individuals with poor speech intelligibility due to severe dysarthma (muscle control). A significant drawback of this device is its expense, to the extent that it is cost-prohibitive for many people. Other augmentative communication devices are available; these range from hand-made communication books or tablets to sophisticated computerized equipment. Various comments are that these also are very costly, ranging from several hundred dollars to five thousand dollars. The devices described above, as well as numerous other devices designed to accomplish the same or similar purposes, have not proven to be completely satisfactory.

### BRIEF DESCRIPTION OF THE INVENTION

The speech coordinator is a lightweight elongated flat material tool with two functions that work separately to improve the speech of individuals with Parkinson' Disease. A preferred embodiment of the tool is approximately 5 inches in length, approximately 1¼ inches in width with two window openings, one located at each end. The first window opening can be adjustable for different colored dots or symbols, with the length and width of the window opening large enough for each individual to determine the best size colored dots or symbols for their individual needs. Having a movable piece of material or paper can be used to accomplish adjustment of the hole size. The material or paper can be raised or lowered from the bottom of the hole to change the size of the hole and/or on the right side of the hole the material or paper can be moved toward the right or left to change the size of the hole. These adjustments by the material or paper can be held in place by Scotch tape or any suitable form of tape or adhesive. With the distance between the first and second ends defining the body's length, and extra thickness “e.g., about ½ inch” is attached to the elongated body between the first and second ends' openings to serve as a handle to control and direct the tool. The function of the first tool opening works in conjunction with the companion card chart that can have different shapes or sizes and can be constructed of paper, plastic or any material which has a smooth and flat surface. The card chart has a plurality of squares, with contrasting shaded or brightly colored dots or symbols with different symbols and colors established by a person using the speech coordinator. These shaded colored dots or symbols are staggered randomly throughout the card chart. The shaded or colored dots or symbols may be found in a constant row of squares or staggered by skipping one, two, or more squares.

If a Parkinson's Disease patient slurs and mumbles words, the tool is placed at the top left square of the chart. The tool is then used to slowly scan each square. When a shaded or colored dot or symbol inside a square appears, this is a signal for a Parkinson's Disease patient to speak a word. The patient then continues to slowly scan the rows of squares to locate the next square that contains a shaded or colored dot or symbol; each time a shaded or colored dot or symbol is visible through the tool opening, the patient stops on the square to speak again. Regulating the rate of speed of speaking can be accomplished by the rate of movement of the tool across the sheet. This deliberate slowing of speaking lets the patient to pronounce words more clearly, minimizing slurring and mumbling of words and giving the patient a method of improving speech communication by artificial timing of the spoken word.

The second function of the Speech Coordinator system that functions separately from the first function uses the second window opening. The height is approximately large enough for one word on one line, but not large enough for two words to be visible on two separate lines. The window opening can be design and manufactured for different size fonts with the length of the window opening being long enough for average words of at least five letters and no more than fifteen letters. Having a movable piece of material or paper can be used to accomplish adjustment of the hole size. The material or paper can be raised or lowered from the bottom of the hole to change the size of the hole and/or on the right side of the hole the material or paper can be moved toward the right or left to change the size of the hole. Scotch tape or any suitable form of tape or adhesive can hold these adjustments by the material or paper in place. This tool works in conjunction with any printed material that the patient might want to read to another individual or group. The purpose of the second opening allows the individual the opportunity to view one word at a time. Allowing the patient to view only one word at a time will regulate the rate or speed and enable the patient to pronounce words more clearly. This will minimize slurring and mumbling of words, and will give the patient a method of improving speech communication by artificial timing “slowing” of spoken words. Both tool openings function separately from each other and use the same manner of artificial timing, thus improving speech communications.

### BRIEF DESCRIPTION OF THE FIGURES OF THE DRAWING

FIG. 1 is a top view of the elongated tool showing openings at both ends.

FIG. 2 shows a side view of the tool's handle.

FIG. 3 shows a top view of the companion card chart.

FIG. 4 shows top view of tool placed on companion card chart showing one shaded or colored dot or symbol through the tool opening.

FIG. 5 shows top view of tool placed on companion card chart showing tool moved to the next square where the shaded or colored dot or symbol is showing through the tool opening.

FIG. 6 shows top view of tool placed on companion card chart showing tool moved to the next square where the shaded or colored dot or symbol is showing through the tool opening.

FIG. 7 shows top view of tool placed printed material with only one word showing through the tool opening.

FIG. 8 shows the top view of tool placed on the next word on the printed material, which is showing through the tool opening.

FIG. 9 shows the top view of tool placed on the next word on the printed material which is showing through the tool opening,

### DETAILED DESCRIPTION OF A PREFERRED EMBODIMENT

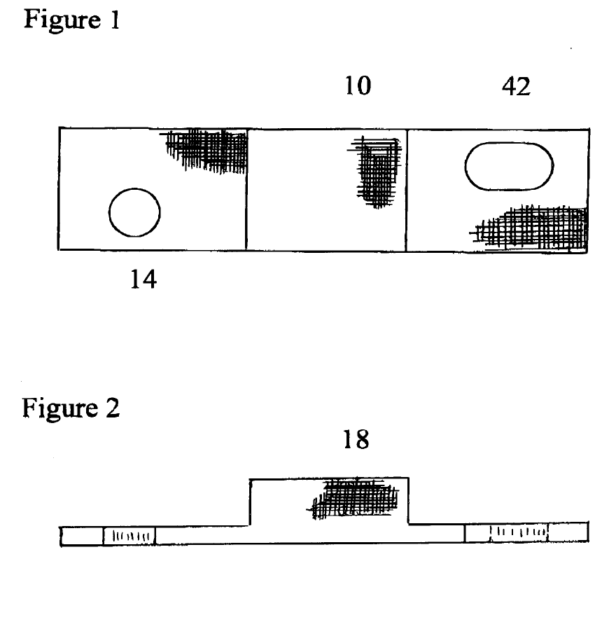

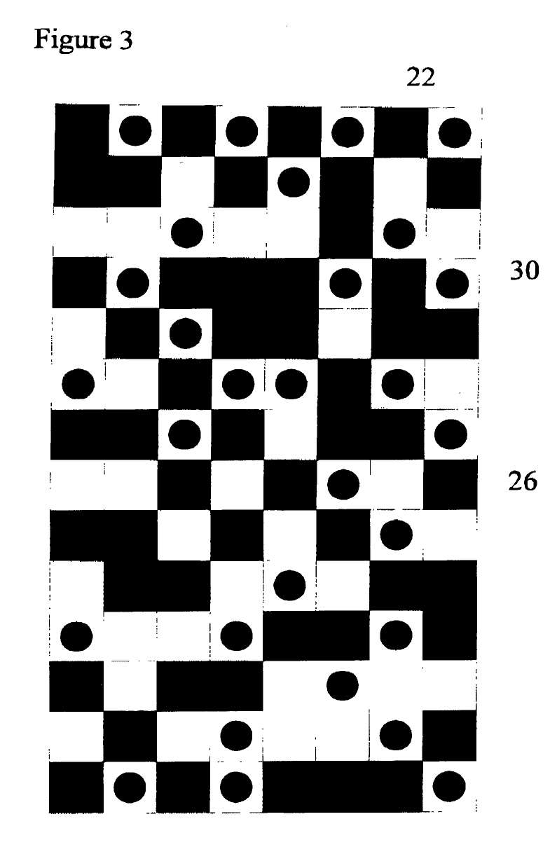

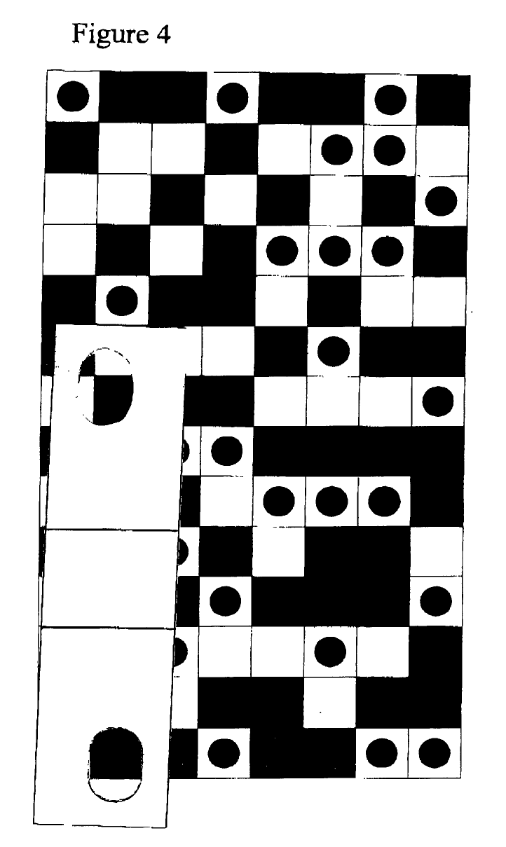

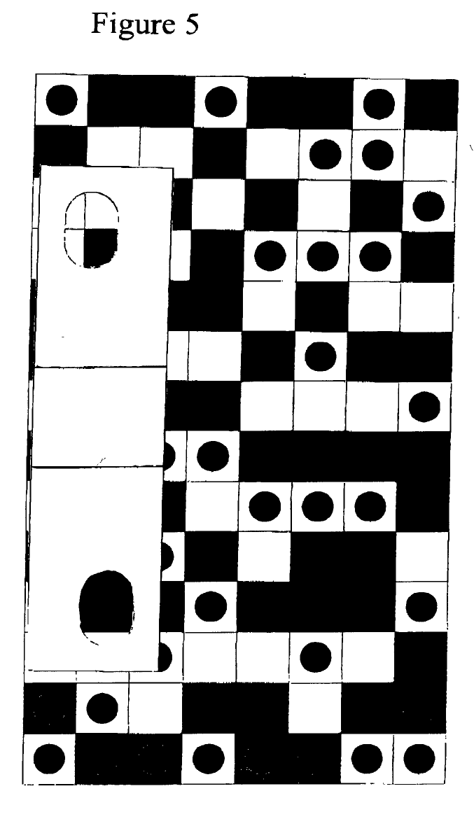

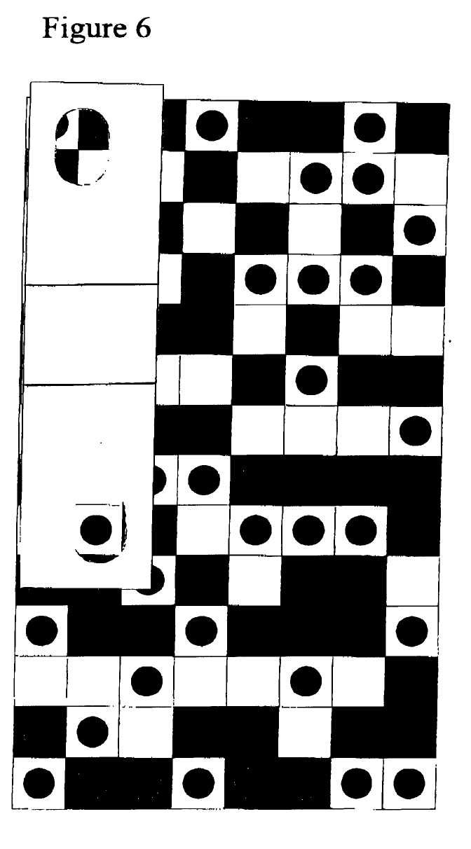

The drawing shows the view of the embodiment of the speech coordinator system in FIG. 1 and 2. A lightweight flat material is approximately 5 inches in length and 1¼ inches wide (10) having first and second openings. The first opening can be adjustable for different colored dots or symbols with the length and width of the window opening large enough for each individual to determine the best size shaded or colored dots or shapes for their individual need. (14). Having a moveable piece of material or paper can do the adjustment of the hole. The material or paper can be raised or lowered from the bottom of the hole to change the size of the hole and/or on the right side of the hole the material or paper can be moved toward the right or left to change the size of the hole. These adjustments can be held in place by scotch tape or any form of glue or tape. The second window opening height is approximately large enough for one word on one line but not large enough for two words on two lines. The window opening can be designed and manufactured to different size fonts with the length of the window opening long enough for average words of at least five letters and no more than fifteen letters. (42). Approximately ½ inch flat extra thickness is attached to the elongated body between the first and second end openings to serve as a handle to control and direct the tool (18). FIG. 3 shows a companion card chart that is used in conjunction with the tool and is made of paper or any suitable material approximately 5 inches wide and approximately 7 inches long (22). The card charts, which can be many different shapes or sizes, contain shaded or colored squares (26); some squares will contain shaded or brightly colored symbols that are very visible to the eye (30). The shaded or colored symbols are staggered throughout the card chart unevenly; some symbols may be found in continuous rows of squares or staggered by skipping one, two, or more squares. On FIG. 4 the companion card chart shows the tool located in the top left-hand comer row. When the Parkinson's Disease patient responds to conversation, the patient moves the tool left to right slowly to the next square with shaded or brightly colored symbols. FIG. 5 shows the companion card chart with the tool opening that has been moved over the next shaded or brightly colored symbol. When the shaded or colored symbol appears in the tool opening, it serves as a signal for a Parkinson's Disease patient to speak usually one word. FIG. 6 shows the tool has moved to the next square with a shaded or brightly colored symbol, which signals the patient to speak again. This will help to slow down and reduce the movement of muscles used for speech coordination and speech production, helping the patient to pronounce each word more clearly.

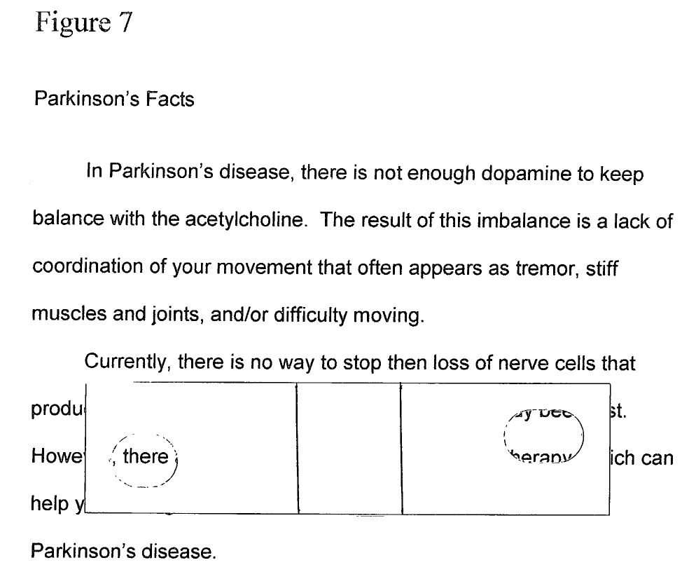

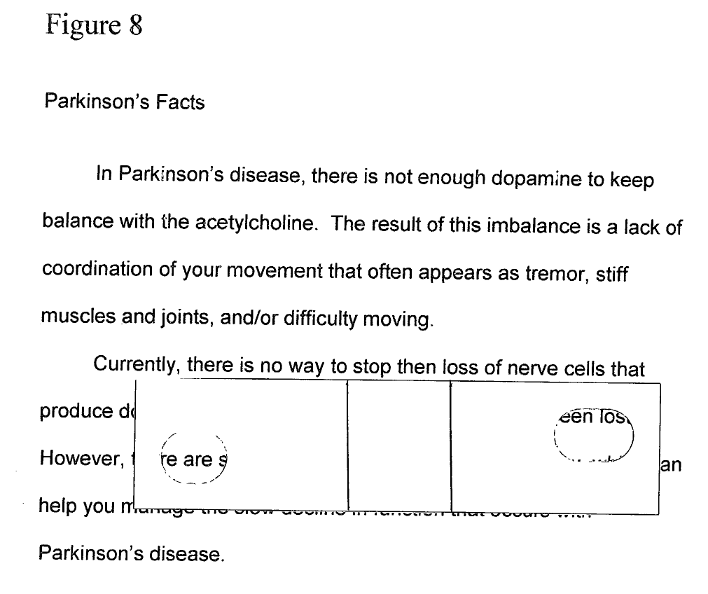

In FIG. 7 the second function of the speech coordinator systems shows the tool with the second window opening on printed material. The window opening height is approximately large enough for one word on one line but not large enough for two words on two lines. The window opening can be adjustable for different size fonts with the length of the window opening long enough for average words of at least five letters and no more than fifteen letters. The window opening view of the printed material is limited so the Parkinson's Disease patient cannot view the upcoming words. This will help to slow down and reduce the movement of muscles used for speech coordination and speech production, helping the patient to pronounce each word more clearly. FIG. 8 shows the tool located on printed material with the tool opening moved to the next word, and the Parkinson patient will pronounce the next word located with the tool opening.

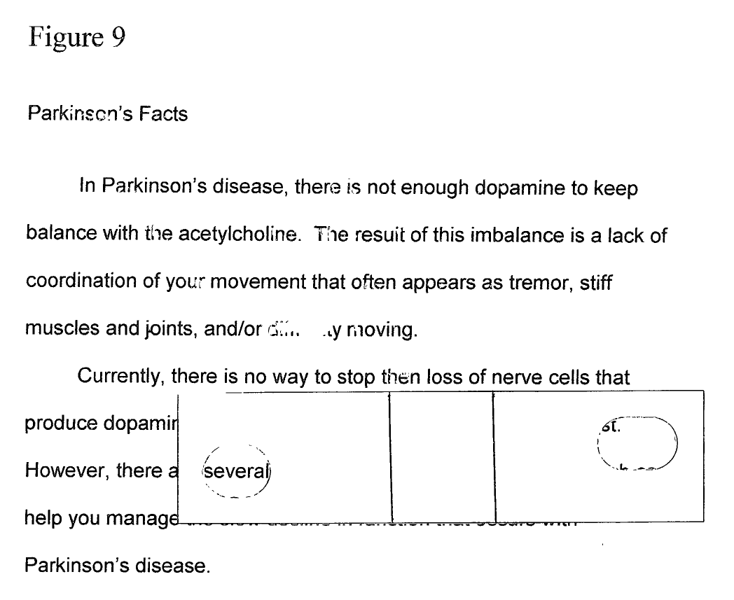

FIG. 9 shows the tool located on printed material with the tool opening moved to the next word and the Parkinson's patient will pronounce the word located within the tool opening. This process should continue when the patient would like to read to an individual or group. This arrangement will cause hesitation and enable the patient to pronounce words more clearly, eliminating slurring and mumbling of a word and giving the patient a method of improving speech communication by artificial timing of the spoken word.

### OBJECTS AND ADVANTAGES

Accordingly, several objects and advantages of my tool are:

1. To provide a tool made of lightweight material having openings located at each end, first window opening can be adjustable of different colored dots or symbols with the length and width of the window opening large enough for each individual to determine the best size colored dots or symbols for their individual needs and this adjustment can be done by having a moveable piece of material or paper that can be raised or lowered from the bottom of the hole to change the size of the hole and/or on the right side of the hole the material or paper can be moved toward the right or left to change the size of the hole and these adjustments can be held in place by Scotch tape or any form of glue of tape, second window opening has a height approximately large enough for one word on one line but not large enough for two words on two lines with the window opening that can be designed or manufactured to a different size fonts with the length of the window opening being long enough for average words of at least five letters and no more than fifteen words; the first window opening can be used with a companion colored card chart that has a plurality of squares, with contrasting shaded or brightly colored dots or symbols with different symbols and colors established by a person using the speech coordinator; using the first window opening to locate these shaded or brightly colored symbols through the opening causes short hesitation and helps to coordinate the articulatory system which in turn helps the Parkinson's Disease patient to pronounce each word more clearly; the second window opening with a height approximately large enough for one word on one line but not large enough for two words on two lines with the window opening be adjustable for different size fonts with the length of the window opening being long enough for average words of at least five letters and no more than fifteen letters; the second window opening on the elongated tool is used for the Parkinson's Disease patient to read printed material aloud; this opening will allow the Parkinson's Disease patient to see and read only one word; changing the rate or speed of speaking will help to improve speech coordination, thus helping the patient to pronounce words more clearly and eliminating a large percent of slurring and mumbling of words

a. to provide a tool that is lightweight to hold and control by a Parkinson's Disease patient

b. to provide a tool that can be placed in one's purse or pocket to be available to Parkinson's Disease patient when needed

c. to provide a tool that can be made from material readily available

d. to provide a tool that is not distracting and bulky

e. to provide a tool that can be handled and used by oneself

f. to provide a tool that is affordable to everyone

What is claimed is:

1. A tool comprising an elongated body made of a material selected from the group that includes metal, aluminum, plastic, and wood, said elongated body being approximately 5 inches in length and about 1¼ inch wide, said body having the first window opening can be adjustable for different colored dots or symbols with the length and width of the window opening large enough for each individual to determine the best size colored dots or symbols for their individual needs, said adjustment is having a moveable piece of material or paper that can be raised or lowered from the bottom of the hole to change the size of the hole and/or on the right side of the hole the material or paper can be moved toward the right or left to change the size of the hole and said adjustment can be held in place by Scotch tape or any form of glue or take, ½ inch extra thickness is attached to the elongated body between the first and second window opening to serve as a handle to control and direct tool, the function of the first window opening on the tool works with the companion card chart, which is made of paper or any suitable material, said card chart having a smooth, flat surface, the card contains a plurality of shaded or brightly colored squares, with contrasting colored dots or symbols with different shapes and colors established by a person using the speech coordinator with these colored dots or symbols staggered randomly throughout the chart:
a) If the Parkinson's Disease patient slurs and mumbles words, said tool is placed at top left of said card chart, then said tool is used to slowly scan each square and seeing a colored dot or symbol inside a square is a signal for a Parkinson's Disease patient to speak a word then the process continues as the patient continues to scan the rows of squares to locate the next square that contains a colored dot or symbol, each time a colored dot or symbol is visible through the window opening the patient stops on the square to speak again, this arrangement results in a short hesitation which enables the patient to consistently take deeper breaths and to pronounce words more clearly eliminating slurring and mumbling of words, giving said patient a method of improving speech communication by artificial timing of the spoken word.

2. Wherein the embodiment has generally elongated flat shape and is made of material selected from the group that includes metal, aluminum, plastic, paper, or wood, said elongated body is approximately 5 inches in length and 1¼ inch wide, having the second window opening height approximately large enough for one word on one line but not large enough to view two words on two lines and having the window adjustable for different size fonts with the length of the window opening long enough for average words of at least five letters and no more than fifteen letters, allowing the patient to view only a few words at one time which causes hesitation and enables the patient to pronounce words more clearly thus eliminating slurring and mumbling of words and giving a method of improving speech communication by artificial timing of the spoken word.

3. The tool as claimed in claim 1 wherein the body a said embodiment has first window opening that can be adjustable for different colored dots or symbols with the length and width of the window opening large enough for each individual to determine the best size colored dots or symbols for their individual needs.

4. wherein said embodiment is approximately ½ inch thick between the first and second openings of said elongated body to serve as a handle.

5. The tool, as claimed in claim 2, works in conjunction with said companion card chart selected and constructed from the group that includes paper, plastic, wood, or metal.

6. The tool as claimed in claim 1 wherein the elongated body has first window opening that can be adjustable for different colored dots or symbols with the length and width of the window large enough for each individual to determine the best size colored dots or symbols for their individual needs, said adjustment is having a moveable piece of material or paper that can be raised or lowered from the bottom of the hole to change the size of the hole and/or on the right side of the hole the material or paper can be moved toward the right or left to change the size of the hole and said adjustment can be held in place by Scotch tape or any form of glue, that will encourage hesitation when speaking, thus helping the Parkinson's Disease patient to consistently take deeper breaths, thus coordinating breathing when speaking.

7. The tool as claimed in claim 1 wherein the elongated body and said companion card chart as claimed in claim 5 wherein said companion card chart which can be many different shapes or sizes has smooth flat surface.

8. The said companion card chart as claimed in claim 6 wherein said companion card chart has a plurality of approximately ½ inch, shaded or brightly colored squares that are easily visible to the eye.

9. The said companion card chart as claimed in claim 7 wherein said companion card chart has shaded or brightly colored symbols staggered throughout the squares of the card, preventing consistency.

10. The tool as claimed in claim 2 wherein said embodiment has a second window opening with the height is approximately large enough for one word on one line but not large enough for two words on two lines, the window opening can be designed and manufactured for different size fonts with the length of the window opening long enough for average words of at least five letters and nor more than fifteen letters, this is used for reading printed material aloud.

11. The tool as claimed in claim 2 wherein said embodiment has second window opening, allowing Parkinson's Disease patient to see and read only one word on one line but not large enough for two words on two lines at a time.

12. The tool as claimed in claim 1 wherein said embodiment has second window opening has a height approximately large enough for one word on one line but not large enough for two words on two lines, the window opening can be designed and manufactured for different size fonts with the length of the window opening being long enough for average words of at least five letters and no more than fifteen letters, this will encourage hesitation when reading, thus improving speech coordination and helping Parkinson's Disease patient to pronounce words more clearly, eliminating a large percent of slurring and mumbling of words.
